(19) United States
(12) Patent Application Publication
(10) Pub. No.: US 2017/0248995 A1
(43) Pub. Date: Aug. 31, 2017

(54) METHODS AND SYSTEMS FOR CONFIGURABLE TEMPERATURE CONTROL OF CONTROLLER PROCESSORS

(71) Applicant: GM GLOBAL TECHNOLOGY OPERATIONS LLC, Detroit, MI (US)

(72) Inventors: Shige WANG, Northville, MI (US); Mark A. ZERBINI, Canton, MI (US)

(73) Assignee: GM GLOBAL TECHNOLOGY OPERATIONS LLC, Detroit, MI (US)

(21) Appl. No.: 15/056,658

(22) Filed: Feb. 29, 2016

(51) Int. Cl. G06F 1/20; G05B 13/04

(52) U.S. Cl. CPC G06F 1/206; G05B 13/048

(57) ABSTRACT

Methods and systems are provided for controlling a temperature of a processor of a controller. In one embodiment, a method includes: collecting a first set of measurement data based on measurement parameters; processing the first set of measurement data associated with the processor using a predictor model to determine a temperature of the processor; and selectively controlling the temperature of the processor based on the determined temperature.

### TECHNICAL FIELD

The technical field generally relates to controllers, and more particularly to methods and systems for controlling a temperature of a controller processor.

### BACKGROUND

Controllers control the operation of one or more components of a system. For example, vehicle controllers control one or more components of a vehicle via associated actuators. Generally, a vehicle controller includes a control program that includes instructions that are performed by a processor for controlling the operation of the component. In some instances, the processor of the controller may overheat due to overuse or environmental conditions. Overheating of the processor may shorten the processor's lifetime and can cause computations performed by the processor to be unreliable.

Accordingly, it is desirable to provide methods and systems for controlling a temperature of a controller processor. It is further desirable to provide methods and systems to configurably control a temperature of a controller processor. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for controlling a temperature of a processor of a controller. In one embodiment, a method includes: collecting a first set of measurement data based on measurement parameters; processing the first set of measurement data associated with the processor using a predictor model to determine a temperature of the processor; and selectively controlling the temperature of the processor based on the determined temperature.

In one embodiment, a system includes a non-transitory computer readable medium. The non-transitory computer readable medium includes a first module that collects a first set of measurement data based on measurement parameters. The non-transitory computer readable medium further includes a second module that processes the first set of measurement data associated with the processor using a predictor model to determine a temperature of the processor. The non-transitory computer readable medium further includes a third module that selectively controls the temperature of the processor based on the determined temperature.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a controller having a temperature control system in accordance with various embodiments;

FIGS. 2 through 5 are dataflow diagrams illustrating the temperature control system in accordance with various embodiments; and

FIG. 6 is a flowchart illustrating a temperature control method in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments may be described herein in terms of functional and/or logical block components and various processing steps. It should be appreciated that such block components may be realized by any number of hardware, software, and/or firmware components configured to perform the specified functions. For example, an embodiment may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of control systems, and that the vehicle system described herein is merely one example embodiment.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in various embodiments.

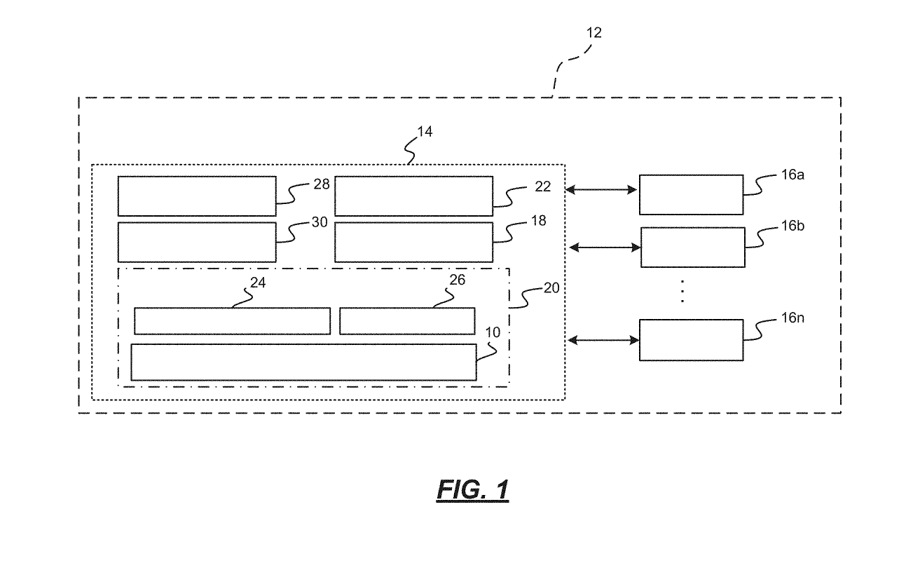

With reference now to FIG. 1, an exemplary temperature control system 10 is shown to be associated with a vehicle 12. As can be appreciated, the vehicle 12 may be any vehicle type such as, but not limited to a road vehicle, an off-road vehicle, an aircraft, a watercraft, a train, etc. As can further be appreciated, the temperature control system 10 may be associated with non-vehicle applications having a controller that controls one or more components. Although the figures shown herein depict an example with certain arrangements of elements, additional intervening elements, devices, features, or components may be present in actual embodiments. It should also be understood that FIG. 1 is merely illustrative and may not be drawn to scale.

As shown, the vehicle 12 includes a controller 14. The controller 14 controls one or more components 16a-16n of the vehicle 12. The controller 14 includes at least one processor 18, memory 20, one or more input and/or output (I/O) devices 22, one or more sensing devices 28, and one or more cooling devices 30. The I/O devices 22 communicate with one or more sensors and/or actuators associated with the components 16a-16n of the vehicle12 to control the components 16a-16n. The sensing devices 28 sense observable conditions associated with the processor 18 and generate sensor signals based thereon. The cooling devices 30 are controlled to cool the processor 18, for example, by fan or other means.

The memory 20 stores instructions that can be performed by the processor 16. The instructions stored in memory 20 may include one or more separate programs, each of which comprises an ordered listing of executable instructions for implementing logical functions. In the example of FIG. 1, the instructions stored in the memory 20 are part of a main operating system (MOS) 24 and one or more applications 26. The applications 26 include the logic for controlling the one or more components 16a-16n. The main operating system 24 includes logic for controlling the performance of the applications 26 and provides scheduling, input-output control, file and data management, memory management, and communication control and related services. In various embodiments, the instructions further include the temperature control system 10 herein described.

When the controller 14 is in operation, the processor 18 is configured to execute the instructions stored within the memory 20, to communicate data to and from the memory 20, and to generally control operations of the vehicle 12 pursuant to the instructions. The processor 18 can be any custom made or commercially available processor, a central processing unit (CPU), an auxiliary processor among several processors associated with the controller 14, a semiconductor based microprocessor (in the form of a microchip or chip set), a macroprocessor, or generally any device for executing instructions.

In various embodiments, the processor 18 executes the instructions of the temperature control system 10. The temperature control system 10 generally monitors and collects data measured by the sensing device(s) 28. The temperature control system 10 processes the data to predict a temperature of the processor 18 and/or a rate of change of temperature associated with the processor 18. The temperature control system 10 controls the temperature of the processor 18 based on the predicted temperature and/or rate of change of temperature.

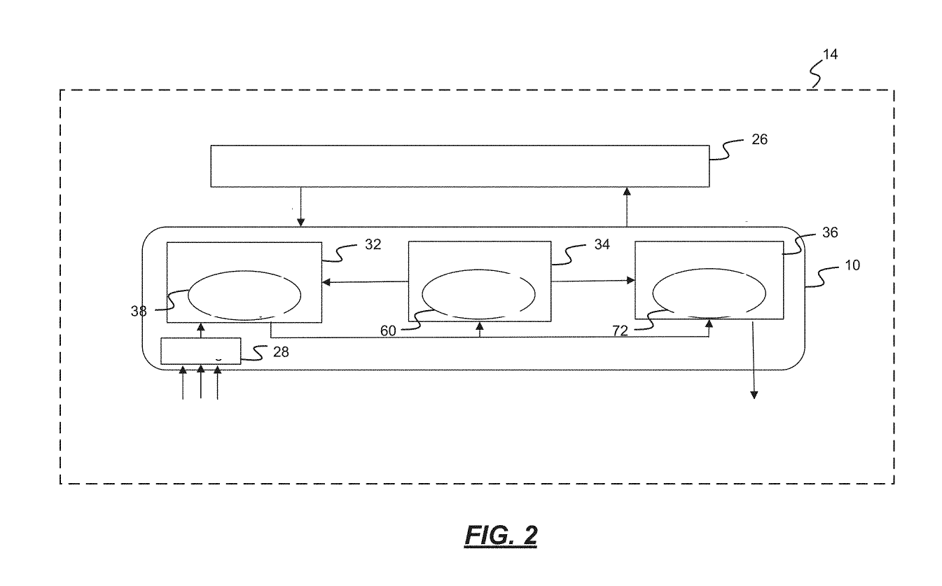

Referring now to FIGS. 2-5 and with continued reference to FIG. 1, dataflow diagrams illustrate the temperature control system 10 in more detail in accordance with various exemplary embodiments. As can be appreciated, various exemplary embodiments of the temperature control system 10, according to the present disclosure, may include any number of modules and/or sub-modules. In various exemplary embodiments, the modules and sub-modules shown in FIGS. 2-5 may be combined and/or further partitioned to similarly monitor and control a temperature of the processor 18. In various embodiments, the temperature control system 10 receives inputs from the one or more sensing devices 28, and/or the application(s) 26. In various embodiments, the temperature control system 10 generates output signals to the one or more cooling devices 30 and/or the application(s) 26. In various exemplary embodiments, the temperature control system 10 includes a monitoring module 32, a predictor module 34, and a controller module 36.

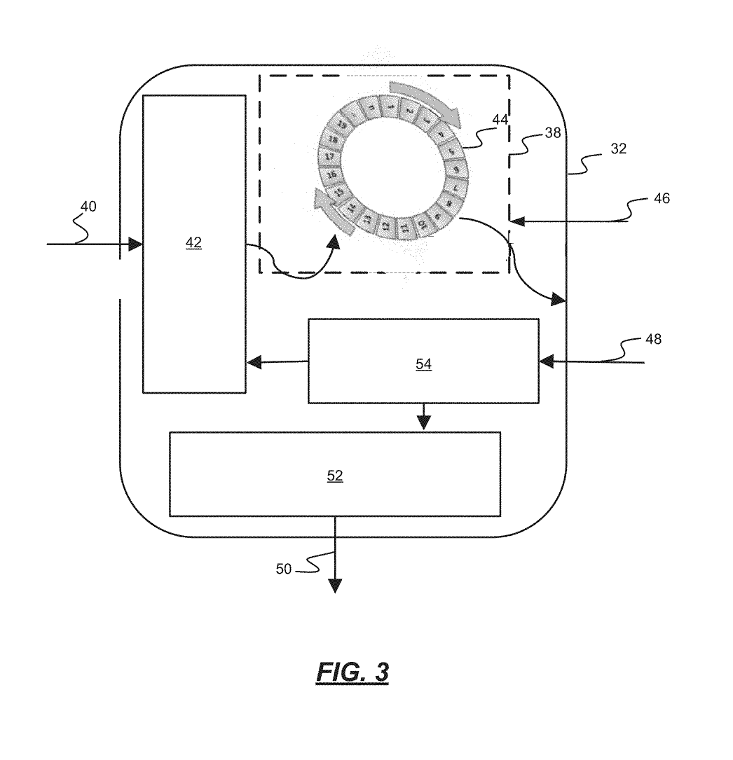

The monitoring module 32 collects and stores measurement data to support the prediction of the temperature and the control of the temperature. The measurement data is stored in a history datastore 38. For example, as shown in greater detail in FIG. 3, measurement data 40 may be provided by the sensing devices 28 of the controller 14 and can include data from a temperature sensor, performance registers, mode registers, etc. The monitoring module 32 collects multiple measurements in a time correlated way. For example, a time-series of measurement data 40 is collected, the data of the time-series is formatted into one or more data structures at 42, and stored in the history datastore 38.

In various embodiments, the history datastore 38 includes a circular buffer 44. The size of the circular buffer 44 and the format of data structures stored in each can be configured. In such embodiments, the monitoring module 32 tracks an index associated with the circular buffer 44. For example, after receiving the measurement data 40 and formatting the measurement data 40 into a data structure, the monitoring module 32 stores the data structure in the circular buffer 44 at allocation associated with the index and then increments the index to the next write position in the circular buffer 44. Once the index reaches the last location in the circular buffer 44, the monitoring module 32 sets the index to the index value associated with the first location. In this manner, once the circular buffer 44 is full, the oldest data is overwritten first.

In another example, after receiving a request 46 to receive data from the history datastore 38, the monitoring module 32 retrieves the data structures associated with the indexes between: index-1 and (index-1)-count, where the count is assumed to be less than the buffer size. The count can be configurable, for example based on the predictor model used by the predictor module 34 (as will be described in more detail below).

In various embodiments, how the data is collected and what data is collected by the monitoring module 32 is configurable. For example, the monitoring module 32 may receive measurement parameters 48 from the predictor module 34 (i.e., based on the predictor model used for the prediction) at 54; and the monitoring module 32 generates a request for the data 50 based on the parameters 48 at 52. The monitoring module 32 further formats the measurement data 40 at 42 based on the measurement parameters 48. For example, the measurement parameters 48 may include, but are not limited to, an indication of direct measurement by way of the temperature sensor, an indication of indirect measurement by way of task level or hardware level sensing (e.g., instruction cycles, cache miss/hit, etc.), uniform sampling, and/or non-uniform sampling.

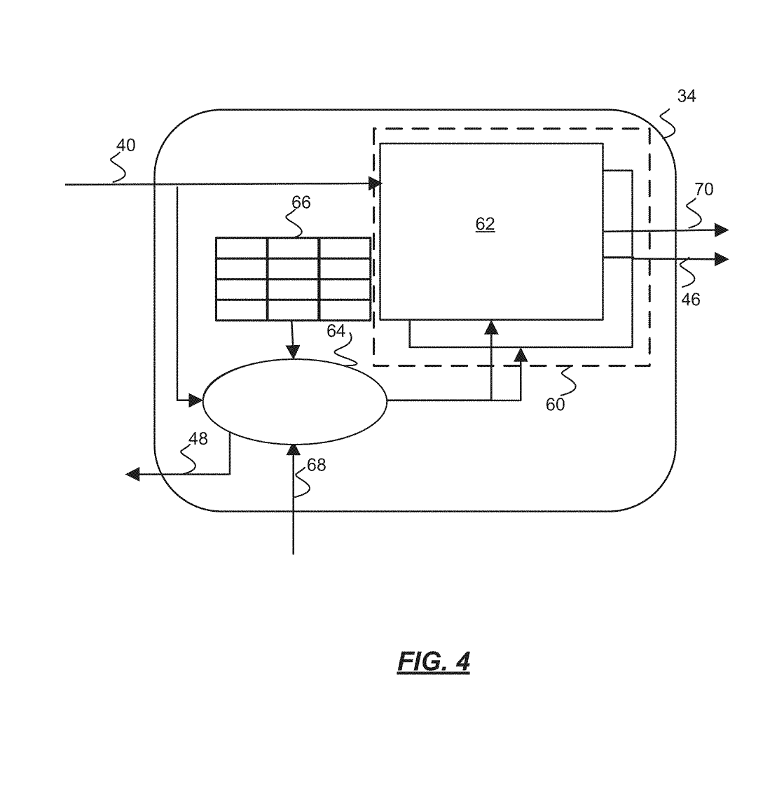

With reference back to FIG. 2, the predictor module 34 computes a temperature of the processor 18 and computes rate of change of the temperature (e.g., how quickly the temperature changes). The predictor module 34 computes the temperature and how quickly the temperature changes based on one or more predictor models stored in a model datastore 60. For example, as shown in more detail in FIG. 4, the model datastore 60 stores one or more predictor models 62. The predictor module 34 selects which predictor model 62 to execute at 64.

For example, the temperature of the processor 18 typically depends on two factors: processor thermal characteristics related to heat transfer and materials (fixed), and application thermal characteristics related to instructions per time unit, memory access, I/O access, etc. The predictor module 34 receives and evaluates current measurement data 40 to select which predictor model to execute.

The predictor module 34 selects the predictor model 62 that would be best suitable for prediction based on the conditions indicated by the current measurement data 40. For example, the predictor module 34 includes a table 66 with structures such as: <current_temperature, current_workload, sensing_state, measure_conf>. The predictor module 34 evaluates the table 66 to decide which predictor model 62 to use and the corresponding measurement parameters 48 to use to measure the data (e.g., current_temp and current_workload from measurement). In various embodiments, the predictor module 34 determines the predictor model 62 to be used based on a current sensing state 68 associated with system services (e.g. diagnostic, indicating availability of sensing devices).

The selected predictor model 62 is then executed by the predictor module 34. The predictor model 62 requests measurements from the monitoring module 32 via the request for data 46 based on the measurement parameters 48. The predictor module 34 then processes the received measurement data 40 using the selected predictor model 62 to generate the predicted temperature and/or the rate of change of the temperature 70. Example predictor models 62 can include, but are not limited to, regressive moving average for uniform temperature measurement:

Tₜ=eₜ₋₁+Σ^{q}ᵢ₌₁(cᵢeₜ₋ᵢ)−Σ^{p}ᵢ₌₁(aᵢTₜ₋ᵢ), and (1)

a band limited temperature frequency uniform workload, non-uniform temperature measurement:

$${T}_{t} = \frac{1}{\sqrt{1 + {( wc )}^{2}}} F ( {U}_{t - 1} ) \qquad ( 2 )$$

With reference back to FIG. 2, the controller module 36 determines if action is necessary based on the predicted temperature and/or rate of change of the temperature 70, and if action is necessary, controls the actions to achieve a desired operating temperature. The controller module 36 determines the actions and controls the actions based one or more policies stored in a policy datastore 72.

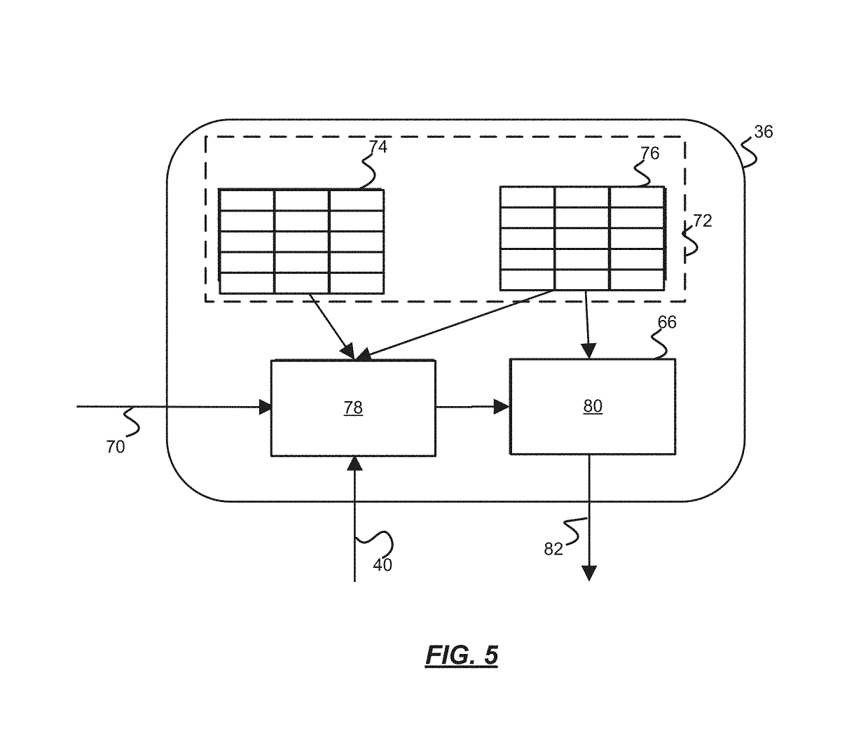

For example, as shown in more detail in FIG. 5, the policy datastore 72 may include a configuration selection table (CST) 74 and a configuration parameter table (CPT) 76. The CST 74 stores relations between current temperature, workload, predicted temperatures, temperature change speed, and a desired configuration (e.g., as discrete values <cur_temperature, cur_workload, pred_temperature, temp_change, des_configure>). The CPT 76 stores configuration parameters for actions of each user-defined policy (e.g., as discret values <config, off_runnables, off_tasks, rbl_rate, tsk_rate, freq>). The controller module 36 computes a CPT entry at 78 based on the CST 74 and measurement data 40. The controller module 36 generates control signals 82 to execute the selected configuration parameters at 80 based on the CPT entry. The configuration parameters are associated with actions that can include, but are not limited to, generate signals to control one or more of the cooling devices (e.g., activation, frequency, voltage adjustment) generate signals to control the processor itself to slow down processing, generate signals to the applications to deactivate runnables and/or tasks, generate signals to the applications to adjust rate, etc.

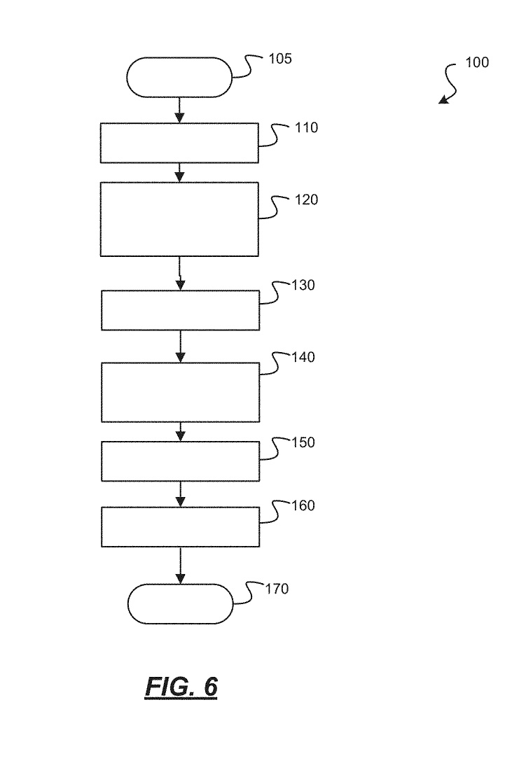

With reference now to FIG. 6, and with continued reference to FIGS. 1 through 5, a flowchart illustrates a method 100 for controlling the temperature of a processor 18 of a controller 14. The method can be implemented in connection with the vehicle 12 of FIG. 1 and can be performed by the temperature control system 10 of FIGS. 2-5, in accordance with various exemplary embodiments. As can be appreciated in light of the disclosure, the order of operation within the method 100 is not limited to the sequential execution as illustrated in FIG. 6, but may be performed in one or more varying orders as applicable and in accordance with the present disclosure. As can further be appreciated, the method 100 of FIG. 6 may be enabled to run continuously, may be scheduled to run at predetermined time intervals during operation of the vehicle 12 and/or may be scheduled to run based on predetermined events.

In various embodiments, the method may begin at 105. The measurement data 40 is received at 110. The measurement data 40 is evaluated by the predictor module 34 to determine the predictor model 62 and the measurement parameters 48 120. The measurement data 40 is collected based on the measurement parameters 48 and the request for data 46 at 130. The collected measurement data 40 is evaluated using the selected predictor model 62 to determine the temperature and/or the rate of change in temperature 70 at 140. The action policy is determined based on the measurement data 40 and the temperature and/or rate of change in temperature 70 at 150. The control signals 80 are generated to carry out the action(s) of the action policy at 160. Thereafter, the method may end at 170.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling a temperature of a processor of a controller, comprising:
collecting a first set of measurement data based on measurement parameters;
processing the first set of measurement data associated with the processor using a predictor model to determine a temperature of the processor; and
selectively controlling the temperature of the processor based on the determined temperature.

2. The method of claim 1, further comprising:
receiving a second set of measurement data associated with the processor; and
determining which predictor model from a plurality of predictor models to use in the processing based on the second set of measurement data.

3. The method of claim 1, further comprising:
receiving a second set of measurement data associated with the processor; and
determining which measurement parameters from a plurality of measurement parameters to use in the processing based on the second set of measurement data.

4. The method of claim 1, wherein the measurement parameters are associated with at least one of an indication of direct measurement, an indication of indirect measurement, an indication of uniform sampling, an indication of non-uniform sampling.

5. The method of claim 1, further comprising:
processing the first set of measurement data associated with the processor using a predictor model to determine a rate of change of the temperature of the processor; and
wherein the selectively controlling the temperature of the processor is further based on the rate of change of the temperature.

6. The method of claim 1, further comprising storing the first set of measurement data as a time series in a circular buffer; and wherein the processing is based on the stored measurement data.

7. The method of claim 1, wherein the selectively controlling is based on an action policy.

8. The method of claim 7, further comprising selecting the action policy from a plurality of pre-defined action policies based on a third set of measurement data.

9. The method of claim 1, wherein the selectively controlling comprises controlling a cooling device of the controller to control the temperature.

10. The method of claim 1, wherein the selectively controlling comprises controlling an execution of an application stored on the controller to control the temperature.

11. The method of claim 1, wherein the selectively controlling comprises controlling the processor to control the temperature.

12. A system for controlling a temperature of a processor of a controller, comprising:
a non-transitory computer readable medium comprising:
a first module that collects a first set of measurement data based on measurement parameters;
a second module that processes the first set of measurement data associated with the processor using a predictor model to determine a temperature of the processor; and
a third module that selectively controls the temperature of the processor based on the determined temperature.

13. The system of claim 12, wherein the second module receives a second set of measurement data associated with the processor, and determines which predictor model from a plurality of predictor models to use in the processing based on the second set of measurement data.

14. The system of claim 12, wherein the second module receives a second set of measurement data associated with the processor, and determines which measurement parameters from a plurality of measurement parameters to use in the processing based on the second set of measurement data.

15. The system of claim 12, wherein the measurement parameters are associated with at least one of an indication of direct measurement, an indication of indirect measurement, an indication of uniform sampling, an indication of non-uniform sampling.

16. The system of claim 12, wherein the second module further processes the first set of measurement data associated with the processor using a predictor model to determine a rate of change of the temperature of the processor; and wherein the third module selectively controls the temperature of the processor further based on the rate of change of the temperature.

17. The system of claim 12, wherein the first module stores the first set of measurement data as a time series in a circular buffer; and wherein the second module processes the stored measurement data.

18. The system of claim 12, wherein the third module selectively controls based on an action policy.

19. The system of claim 18, wherein the third module selects the action policy from a plurality of pre-defined action policies based on a third set of measurement data.

20. The system of claim 12, wherein the third module selectively controls by controlling at least one of a cooling device of the controller, an execution of an application stored on the controller, and the processor to control the temperature.
